(19) United States
(12) Patent Application Publication
(10) Pub. No.: US 2009/0264106 A1
(43) Pub. Date: Oct. 22, 2009

(54) METHOD AND DEVICE FOR IMPLEMENTING DYNAMIC GROUPS

(76) Inventors: Caiwen MO, Shenzhen (CN); Gang Shao, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/494,968

(22) Filed: Jun. 30, 2009

Related U.S. Application Data
(63) Continuation of application No. PCT/CN2008/070364, filed on Feb. 27, 2008.

(30) Foreign Application Priority Data
Mar. 29, 2007 (CN) 200710073932.9

(51) Int. Cl. H04M 1/663; H04W 4/00

(52) U.S. Cl. 455/412.2; 455/432.1; 455/433

(57) ABSTRACT

A method for implementing dynamic groups includes: receiving a roam notification message of a roaming user, wherein the roam notification message includes location information; finding pal information that matches the location information carried in the roam notification message from an address book of the user; and creating a group according to the matching pal information. The method creates a group for the user dynamically according to the roam location of the user. Through the dynamic group, the user in the roaming state obtains the information on the pals in the roam area quickly, and contacts the pals conveniently and quickly. Therefore, the user experience is improved and operators may implement value-added services based on the dynamic group. A device for implementing dynamic groups is also disclosed.

This application is a continuation of International Patent Application No. PCT/CN2008/070364, filed Feb. 27, 2008, which claims the benefit of priority of Chinese Patent Application No. 200710073932.9, filed with the Chinese Patent Office on Mar. 29, 2007, and entitled “Method and Device for Implementing Dynamic Groups”, all of which are incorporated herein by reference in their entireties.

### FIELD OF THE DISCLOSURE

The present disclosure relates to communication technologies, and in particular, to a method and device for implementing dynamic groups.

### BACKGROUND

As communication devices and mechanisms become more and more developed, people can contact each other in wider areas, and are free from restriction of geographic areas. A user may have frequent contact with pals in many cities and regions, and generally store the contact modes of such remote pals in the mobile station. When roaming to a remote area, the user may contact the pals in this visited area. However, the telephone numbers of the pals stored in the mobile station are usually distributed separately, and are hard to find; or the user does not remember which pals in the visited area are recorded in the address book of the mobile station at all.

In the conventional roaming reminder technology, a Home Location Register (HLR) is reconstructed and a roaming prompt server is added to implement the roaming reminder service through a short message. Therefore, when the user roams to an area, the user receives a short message of greeting or advertisement reminder from the local operator, or the user may query the current roaming region through a short message. However, this service provides only basic roaming reminder services for the user, and no further services are available, for example, displaying a list of pals in the roam area to the user.

The Personal Information Management (PIM) service in the conventional art provides the personal information storage and management service, for example, stores contact information of relatives, friends and clients in the address book on the mobile station of the user. The address book backed up and recovered for the user provides secure and convenient services. In the PIM service currently available, the user is allowed only to synchronize the information in the mobile station with a computer or mobile network server by wireless or wired means, and query and manage the address book through multiple terminals and access means. However, the user is unable to dynamically divide the contact numbers in the address book into groups according to the conditions provided by the user or service server. The services derived from such groups are not supported either. For example, a list of contact numbers in a specific group is sent to the user so that the user can conveniently get in touch with the pals in the roam area. The user can automatically combine the pals in the roam area into a Virtual Private Network (VPN) group, to which a VPN short number is assigned.

In the process of researching the present disclosure, the following defects are found in the conventional art: the prior art provides only basic roaming reminder services for the user, providing no further services, and the user is unable to dynamically divide the contact numbers in the address book into groups according to the conditions provided by the user or service server. Thus, the services derived from such groups are not supported either.

### SUMMARY

The embodiment of the present disclosure provides a method and device for implementing dynamic groups so that the user may dynamically divide the contact numbers in the address book on the mobile station into groups according to the roaming state of the user and manage and store the groups.

A method for implementing dynamic groups in an embodiment of the present disclosure includes the following steps: receiving a roam notification message of a roaming user, where the roam notification message includes location information; finding, from an address book of the user, pal information that matches the location information carried in the roam notification message; and creating a group according to the matching pal information.

A device for implementing dynamic groups in an embodiment of the present disclosure includes: a condition resolving module, adapted to receive the roam notification message of a roaming user, and resolve the location information of the roaming user from the roam notification message; and a group matching module adapted to find pal information that matches the location information of the roaming user from the address book of the user, and create a group according to the pal information.

Compared with the conventional art, the method or device provided in an embodiment of the present disclosure obtains location information of the roaming user, finds the pals whose home area matches the location information of the roaming user from the address book of the user, and creates a group according to the address information. Therefore, better services based on the group are available, for example, when the user roams to a remote city, the user may find the group of the pals in this city quickly and get in touch with them conveniently. Network operators may provide better value-added services and service experience for the user, for example, roam area pal notification service, and same-city VPN service.

### BRIEF DESCRIPTION OF THE DRAWINGS

FIG. 1 is a flowchart of a method for implementing dynamic groups in an embodiment of the present disclosure;

FIG. 2 shows a structure of a system for implementing address book groups of the user based on a PIM server in an embodiment of the present disclosure;

FIG. 3 is a flowchart of a method for implementing embodiments of the present disclosure;

FIG. 4 shows a structure of a system for implementing address book groups of the user based on a mobile station in an embodiment of the present disclosure;

FIG. 5 shows a structure of a matching module in a PIM server or mobile station provided in an embodiment of the present disclosure; and

FIG. 6 shows another structure of a PIM server provided in an embodiment of the present disclosure.

### DETAILED DESCRIPTION

A method for implementing dynamic groups in an embodiment of the present disclosure includes: resolving, when a mobile station user roams, the location information of the roam area of the user according to the roam notification message of the user; querying the mobile number segment table to find the range of the mobile numbers of the current roam area of the mobile station user; finding, from the address book of the mobile station user, the pals whose home area matches the location information of the roaming user according to the range of mobile numbers; and creating a group according to the information on the matching pals.

The present disclosure is hereinafter described in more detail by reference to the embodiments of the present disclosure.

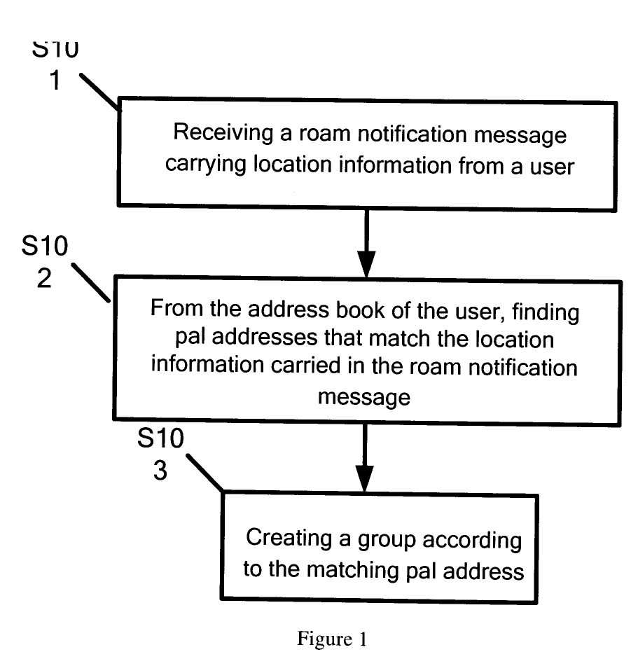

As shown in FIG. 1, the method for implementing dynamic groups in an embodiment of the present disclosure includes the following steps:

Step S101: Receiving the roam notification message of the roaming user, where the roam notification message carries location information;

Step S102: Finding pal information that matches the location information carried in the roam notification message from the address book of the user; and

Step S103: Creating a group according to the pal information.

In an embodiment of the present disclosure, the foregoing dynamic groups may be implemented through a system composed of a PIM server, Mobile Switching Center (MSC), Visitor Location Register (VLR), Home Location Register (HLR), and Short Message Service Centre (SMSC), and may be implemented through a system composed of a terminal device, MSC, VLR, HLR, and SMSC.

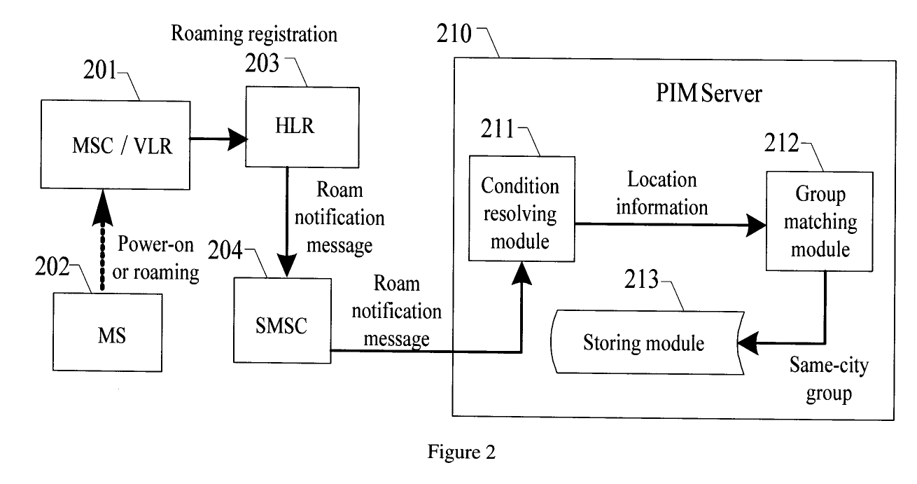

The following description supposes that the dynamic groups are implemented through a system composed of a PIM server 210, MSC/VLR 201, HLR 203 and SMSC 204 in an embodiment of the present disclosure. FIG. 2 shows a structure of the system. In a mobile communication system, the roaming process is implemented through logic collaboration between the entities such as HLR 203 and MSC/VLR 201, where: the HLR 203 is adapted to record the current location information of the mobile user and all user data; the VLR 201 is adapted to record the user data related to the mobile users who roam to a location area controlled by the VLR 201, and allocate a Mobile Station Roaming Number (MSDN) to the roaming user; the MSC 201 is adapted to handle the location registration process of the mobile user, communicate with the mobile user, and exchange information with the HLR 203 and VLR 201; the SMSC 204 is adapted to send a roam notification message to the PIM server 210 when the user is in the roaming state, where the message carries the roam location information of the user; and the PIM server 210 is adapted to find the address information whose home area is the roam area of the user from the address book of the user according to the location information in the obtained roam notification message, and create a group according to the address information.

The process of finding the address information and creating a group according to the address information in an embodiment of the present disclosure includes the following four steps.

Step 1: When detecting that the user is roaming, the HLR 203 generates a roam notification message, and sends the roam notification message to the PIM server 210 using, for example, a short message. The roam notification message carries the location information of the roaming user. The roam notification message carries a Mobile Station International ISDN Number (MSISDN) and a Mobile Station Roaming Number (MSRN). The MSRN is the location information. The format of the MSRN matches the format of the MSISDN, and the MSRN is allocated by the VLR 201 in the roam area of the user.

Step 2: The PIM server 210 analyzes the roam notification message, and resolves the MSISDN and MSRN of the user from the message.

Step 3: According to the location information in the roam notification message of the user, the PIM server 210 finds the pals whose home area matches the location information.

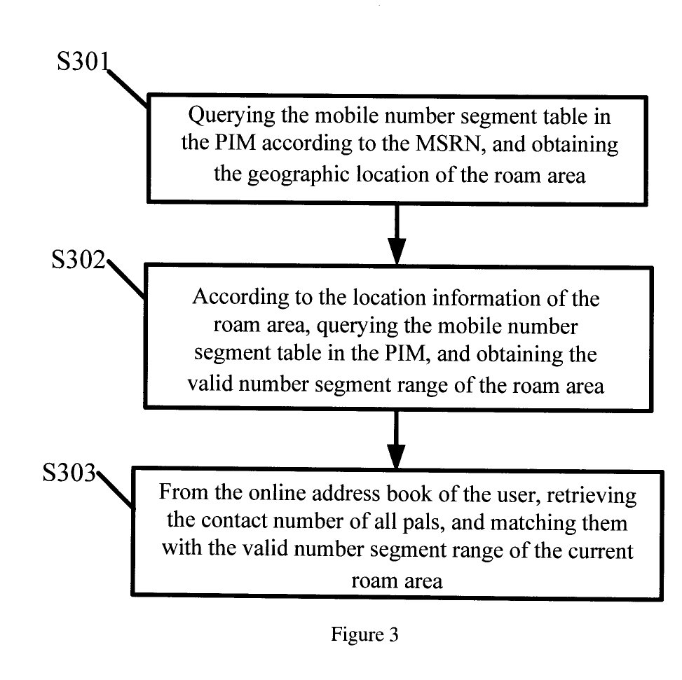

Referring to FIG. 3, the finding process of the PIM server 210, as discussed in Step 3, is as follows: Step S301: Querying the mobile number segment table in the PIM server 210 according to the MSRN, and obtaining the geographic location of the roam area. That is, querying the location of the roam area of the user in the mobile number segment according to the current roaming VLR Identification Number (VLRIN) of the user.

The mobile number segment table includes the telecom number segment information of the telecom operator based on the geographic area. The number segment table helps determine the geographic location of a telephone number or the telephone number segment range corresponding to a geographic area.

In the current numbering plan of mobile communication networks, the general format of the MSRN is CC-NDC-H0H1H2H3—ABCD, where: CC: Country Code, for example, the CC of China is 86; NDC: National Destination Code, for example, the NDC of China Unicom is 130-133, and the NDC of China Mobile is 134-139; H0H1H2H3 corresponds to each VLRIN.

Table 1 shows the corresponding relation between the MSRN and the location information.

TABLE 1

| CC | NDC | H0H1H2H3 | Location |
|---|---|---|---|
| 86 | 134 | 1039~2419 | Shenzhen |
| | 137 | 1472~3564 | Shenzhen |
| | 138 | 2652~5648 | Shenzhen |
| | 138 | 0805~0999 | Chengdu |
| | . . . | . . . | . . . |

For example, after a Chengdu user whose MSISDN is 8613808058945 roams to Shenzhen, the visited VLR of the user allocates an MSRN “13810409999” to the user, where 1040 represents the VLRIN. Thus, the analysis in Table 1 reveals that the user is currently in Shenzhen.

Step S302: According to the location information of the roam area, querying the mobile number segment table in the PIM server 210, and obtaining the valid number segment range of the roam area. That is, querying the valid telephone number segment range corresponding to an area according to the preset rules of the operator.

For example, after it is determined that the user currently roams to Shenzhen, the resolving module searches the mobile number segment table and finds that the valid number segment range of the current roam area is 1341039˜1342419, 1371472˜1373564 and 1382652˜1385648 through matching.

Table 2 is a mobile number segment table.

TABLE 2

| CC | Location | NDC | H0H1H2H3 range |
|---|---|---|---|
| 86 | Shenzhen | 134 | 1039~2419 |
| | Shenzhen | 137 | 1472~3564 |
| | Shenzhen | 138 | 2652~5648 |
| | . . . | . . . | . . . |

Step S303: From the online address book of the user, retrieving the contact numbers of all pals, and matching them with the valid number segment range of the current roam area. If the contact number of a pal falls within the number segment range, it indicates that the home area of the pal corresponding to the number is the current roam area of the user. For example, by querying the online address book of the user 8613808058945, the group matching module in the PIM server 210 retrieves the contact numbers of all pals in the online address book of the user, and matches them with the valid number segment range of the current roam area. If the contact number of a pal falls within the number segment range, it indicates that the pal corresponding to the number is located in the current roam area of the user.

Step 4. The matching results of the group matching module 212 are constructed into a group, which is called “same-city pal group” of the user. The same-city pal group is implemented in two ways:

(1) A new storing module 213 is created independently of the user online address book in the PIM server 210, and the group is stored. The data structure of the group is shown in Table 3.

TABLE 3

| Group Number | | |
|---|---|---|
| (Number in | Contact ID | |
| the group) | (ID of the pal in the online address book) | Description |
| 1 | ContactID1 (for example, 135 * * * ) | * * * |
| 2 | ContactID2 | * * * |
| 3 | ContactID3 | * * * |

(2) A special same-city pal group ID is defined based on the storage mode of the existing user online address book in the PIM server 210, and the current same-city pal group ID (Active Group ID) is added into “Group ID” of the existing user online address book, as shown in Table 4:

TABLE 4

| Contact ID | Group ID |
|---|---|
| 138 * * * 12 | 1, Active Group ID |
| 13456 * * * | 1, 2 |
| 135 * * * 58 | Active Group ID |

In Table 4, “Contact ID” is the ID of a pal in the PIM, for example, the telephone number of the pal. “Group ID” is the ID of the group that includes the pal. “Active Group ID” is the same-city pal group ID of the user. “1” and “2” in the “Group ID” are IDs of other groups that include the pal.

The relevant service is carried out based on the created same-city pal group, for example, the roam area pal notification service, which delivers the group to the user terminal; same-city pal VPN service, which allocates a VPN short number to each pal in the group and constructs a VPN group.

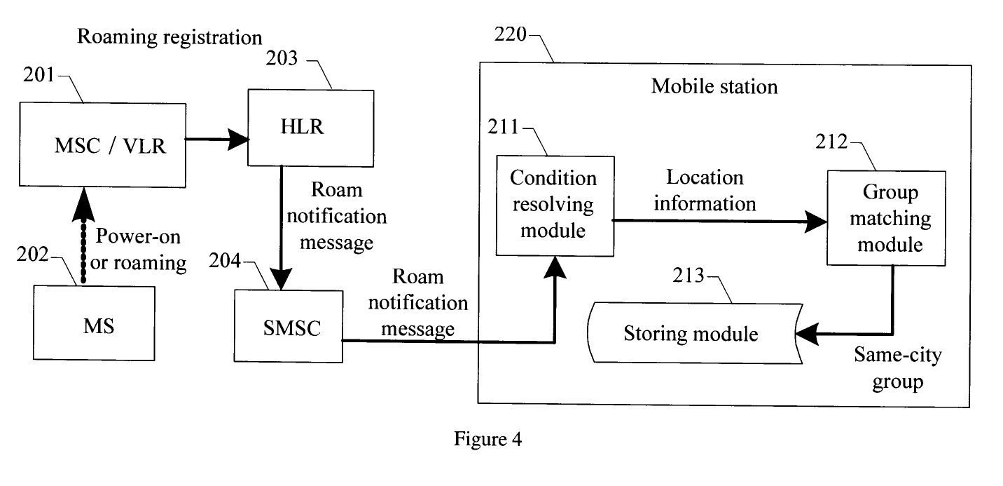

A system including a mobile station 220, MSC/VLR 201, HLR 203, and SMSC 204 is disclosed herein to implement the dynamic group method. The structure of the system is shown in FIG. 4. This system differs from the system in FIG. 2 in that the functional modules such as condition resolving module 211, group matching module 212 and storing module 213 are set inside the mobile station 220. The detailed method of matching the address information whose home area is the roam area of the user in the address book of the user according to location information of the user, and creating a group according to the matching address information, is the same as the implementation method of the system in FIG. 2 and not repeated here any further.

A device for implementing dynamic groups is disclosed in an embodiment of the present disclosure. The device may be a PIM server 210 or mobile station 220. For the structure of the device, refer to FIG. 2, the PIM server 210 structure in the system structure diagram, and the user terminal or mobile station 220 structure in the system structure diagram in FIG. 4.

As shown in FIG. 4, the structure of the mobile station 220 includes: a condition resolving module 211 adapted to receive the roam notification message of the roaming user, and resolve the location information of the roaming user from the roam notification message; a group matching module 212 adapted to find the pals whose home area matches the location information from the address book of the user, and construct the matching pals into a same-city pal group of the user; and a storing module 213 adapted to store the same-city pal group list.

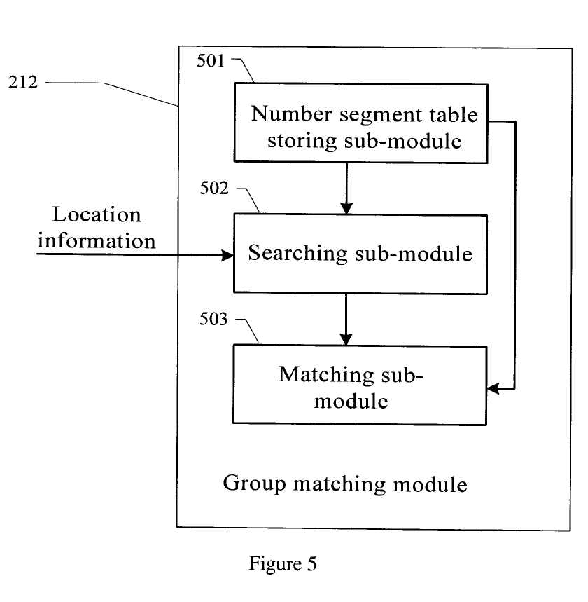

FIG. 5 shows a structure of a group matching module 212. The group matching module 212 includes: a number segment table storing sub-module 501, adapted to store number segment tables; a searching sub-module 502 adapted to search the number segment table for the number segment range corresponding to the location information; and a matching sub-module 503 adapted to find, from the address book of the user, the pals whose home area matches the location information according to the number segment range.

The PIM server 210 in FIG. 2 or the mobile station in FIG. 4 may store the constructed same-city pal group list separately into the storing module 213. The created group may also be presented by adding identification information into the matching address information rather than being stored separately.

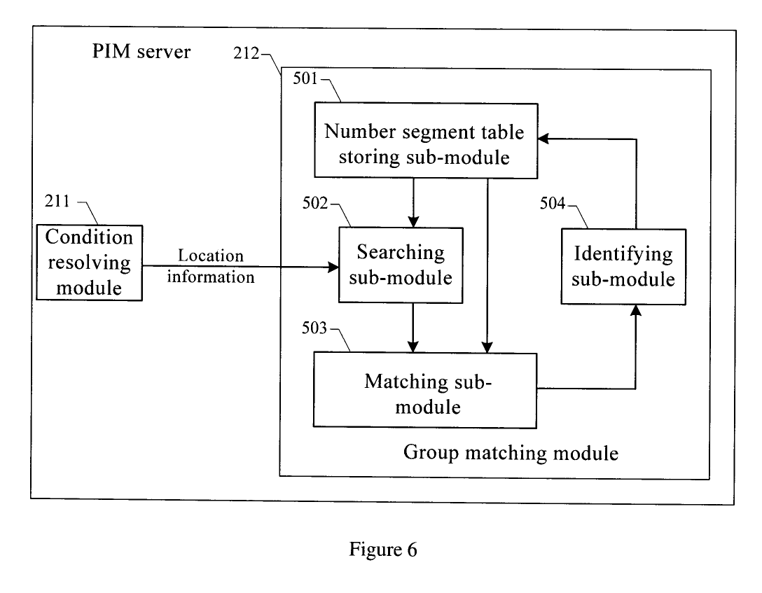

As shown in FIG. 6, if the same-city pal is identified directly in the address book through the identification information, taking the PIM server 210 as an example, the group matching module further includes: an identifying sub-module 504 adapted to: add, in the address book of the user, identification information into the matching pal information to identify the same-city pal group; and store the pal groups with the identification information into the number segment table storing sub-module 501. The connection relations between other modules and their functions are the same as those of the modules illustrated in FIG. 5.

The structure of the mobile station is the same as the PIM server 210, and is not repeated here any further.

When the device implements the function of the same-city pal group of the user at the network side, the device is a PIM server 210. When the device implements the function of the same-city pal group of the user at the user terminal side, the device is a mobile station 220.

The foregoing embodiment is only one of the preferred embodiments of the present disclosure. Many technical solutions are disclosed in the present disclosure. For example, the roam notification message may be sent by the SMSC 204 to the condition resolving module 211 in the PIM server 210, or sent by the network devices such as HLR 203 and VLR 201 to the condition resolving module 211 in the PIM server 210. When the mobile user is unable to implement the PIM service, the roam notification message may be sent to the mobile station 220 through a short message, and the mobile station 220 constructs a same-city pal group.

Through the foregoing embodiments, those skilled in the art understand that the disclosure may be realized through software and general hardware platforms or through hardware only. In most cases, it is preferred to use software and general hardware platforms. Based on such understandings, the technical solution under the present disclosure or contributions to the conventional art can be embodied by software products. The software is stored in a storage medium and incorporates several instructions to instruct a computer device, for example, a PC, server, or network device, to execute the method provided in the embodiments of the present disclosure.

The embodiments described above are only preferred embodiments that are not intended to limit the protection scope of the present disclosure. It is apparent that those skilled in the art can make various modifications and variations to the disclosure without departing from the spirit and scope of the disclosure. The disclosure is intended to cover the modifications and variations provided that they fall in the scope of protection defined by the following claims or their equivalents.

What is claimed is:

1. A method for implementing dynamic groups, comprising:
receiving a roam notification message of a roaming user, wherein the roam notification message carries location information;
finding, from an address book of the roaming user, pal information that matches the location information carried in the roam notification message; and
creating a group according to the pal information.

2. The method of claim 1, wherein the finding the pal information that matches the location information carried in the roam notification message comprises:
searching a number segment table for a number segment range corresponding to the location information carried in the roam notification message; and
finding, from the address book of the roaming user, pal information that matches the location information carried in the roam notification message according to the number segment range.

3. The method of claim 1, wherein the creating the group according to the pal information comprises:
storing the pal information as a separate group list.

4. The method of claim 1, wherein the creating the group according to the pal information comprises:
adding identification information to the pal information to identify the pal information as a same group in the address book of the roaming user.

5. The method of claim 1, further comprising:
sending the created group to the roaming user.

6. A device for implementing dynamic groups, comprising:
a condition resolving module, adapted to receive a roam notification message of a roaming user, and resolve location information of the roaming user from the roam notification message; and
a group matching module adapted to find pal information that matches the location information of the roaming user from an address book of the roaming user, and create a group according to the pal information.

7. The device of claim 6, further comprising:
a storing module adapted to store the created group according to the pal information.

8. The device of claim 6, wherein the group matching module comprises:
a number segment table storing sub-module adapted to store a number segment table;
a searching sub-module adapted to search the number segment table for a number segment range corresponding to the location information; and
a matching sub-module adapted to find the pal information that matches the location information of the roaming user from the address book of the roaming user according to the number segment range.

9. The device of claim 8, wherein the group matching module further comprises:
an identifying sub-module adapted to add identification information into the pal information in the address book of the roaming user to identify the pal information as a same group.

10. The device according to claim 6, wherein the device is one of a Personal Information Management (PIM) server or a user terminal.

11. A system for implementing dynamic groups, comprising:
a Home Location Register (HLR); and
a Personal Information Management (PIM) server;
wherein the HLR is adapted to generate a roam notification message of a roaming user, and send the roam notification message to the PIM server, and wherein the roam notification message carries location information, and
wherein the PIM server is adapted to receive a roam notification message, resolve location information of the roaming user from the roam notification message, find pal information that matches the location information of the roaming user from an address book of the roaming user, and create a group according to the pal information.

12. The system of claim 11, wherein the PIM server is further adapted to add identification information into the pal information in the address book of the roaming user to identify the pal information as a same group.

13. A system for implementing dynamic groups, comprising:
a Home Location Register (HLR); and
a user terminal;
wherein the HLR is adapted to generate a roam notification message of a roaming user, and send the roam notification message to the user terminal, and wherein the roam notification message carries location information; and
wherein the user terminal is adapted to receive a roam notification message, resolve location information of the roaming user from the roam notification message, find pal information that matches the location information of the roaming user from an address book of the roaming user, and create a group according to the pal information.

14. The system of claim 13, wherein the user terminal is further adapted to add identification information into the pal information in the address book of the roaming user to identify the pal information as a same group.

15. A computer readable media, embodying computer executable instructions for implementing dynamic groups, which, when executed by a machine, is operable to cause the machine to perform a method comprising:
receiving a roam notification message of a roaming user, wherein the roam notification message carries location information;
finding, from an address book of the roaming user, pal information that matches the location information carried in the roam notification message; and
creating a group according to the pal information.

16. The computer readable media of claim 15, wherein the computer executable instructions cause the machine to perform a method further comprising:
adding identification information to the pal information in the address book of the roaming user to identify the pal information as a same group.
